(19) United States
(12) Patent Application Publication
(10) Pub. No.: US 2012/0159549 A1
(43) Pub. Date: Jun. 21, 2012

(54) SONY EPG AND METADATA SOLUTION WITH MULTIPLE SERVICE SOURCES

(76) Inventors: Ludovic Douillet, Escondido, CA (US); Klaus Hofrichter, San Diego, CA (US); Jenke Wu Kuo, San Diego, CA (US); Aran Sadja, San Diego, CA (US); William Schupp, San Diego, CA (US)

(21) Appl. No.: 13/291,075

(22) Filed: Nov. 7, 2011

Related U.S. Application Data
(60) Provisional application No. 61/411,253, filed on Nov. 8, 2010.

(51) Int. Cl. H04N 21/482

(52) U.S. Cl. 725/42; 725/48

(57) ABSTRACT

A system, method, and computer program product are provided for combining electronic program guide data and metadata input from multiple service providers to a common gateway server that connects to consumer electronics devices. A unified interface enables users of a wide variety of consumer electronics devices to easily manage broadcast contents and network services, typically in real-time. In addition to traditional TV EPG applications such as on-screen menus and program descriptions, channel/program searching, and timer and DVR functions, the embodiments provide enhanced metadata features through an Internet connection, including media explorers, streaming content, recommendations and customized advertisements and related searches, and social networking applications. The server manages metadata format translation, and merges content to transparently switch between content providers.

### CROSS-REFERENCE TO RELATED APPLICATIONS

This application claims the benefit under 35 U.S.C. 119 of provisional application 61/411,253 filed on Nov. 8, 2010 entitled “Sony EPG and Metadata Solution With Multiple Service Sources” which is hereby incorporated by reference in its entirety.

### FIELD OF THE INVENTION

The present patent document relates in general to electronic program guide (EPG) systems, more specifically to an interface for enabling electronic program guide data and metadata input from multiple service providers.

### BACKGROUND OF THE INVENTION

Home networking capability is rapidly becoming a must-have feature on today's consumer electronics (CE) products. The addition of interne access to consumer electronics products provides new opportunities to improve and enhance existing capabilities. One of these potential improvements is in the acquisition of electronic program guide data and metadata. Currently, a number of different data providers are used for regional electronic program guide acquisition; this requires multiple client side implementations.

This patent application provides a viable approach to solving this challenge and presents a practical implementation of that technique.

### SUMMARY OF THE EMBODIMENTS

A system, method, and computer program product for an electronic program guide and metadata solution with multiple service sources are disclosed and claimed herein. An exemplary computer-implemented method embodiment may comprise receiving input comprising at least one of electronic program guide data and metadata from a plurality of content providers, combining the input in a common gateway server, and generating a unified interface for at least one consumer electronics device. The electronic program guide data may comprise a channel lineup, a channel logo, a program list, and/or DVR instructions. The metadata may comprise information regarding streaming video, explorer tools, recommendations, customized advertisements, and/or social networking applications. The metadata may comprise file formats such as text, protocol buffer, JSON, and/or XML. The content providers may comprise broadcasters, advertisement providers, metadata providers, IPTV providers, and/or movie providers. The receiving may be from a broadcast source, a network source, and/or the interne.

The embodiment may filter, transcode data from at least one external application program interface, and/or merge data. The combining enables transparently switching between metadata service providers. The common gateway server comprises a service manager and a database manager. The unified interface comprises an application program interface common to a plurality of the consumer electronic devices, which may include a smartphone, a television set, a laptop computer, a tablet computer, a personal digital assistant, a video game, and/or a personal computer. The embodiment may also integrate electronic program guide service with related advertisements. The embodiment preferably operates in substantially real-time.

A system embodiment may comprise a processor and a memory containing instructions that, when executed by the processor cause the processor to receive input comprising at least one of electronic program guide data and metadata from a plurality of content providers, combine the input in a common gateway server, and generate a unified interface for at least one consumer electronics device.

A computer program product embodiment may comprise a computer readable medium tangibly embodying non-transitory computer-executable program instructions thereon that, when executed, cause a computing device to receive input comprising at least one of electronic program guide data and metadata from a plurality of content providers, combine the input in a common gateway server, and generate a unified interface for at least one consumer electronics device.

As described more fully below, the apparatus and processes of the embodiments disclosed provide an electronic program guide and metadata solution with multiple service sources. Further aspects, objects, desirable features, and advantages of the apparatus and methods disclosed herein will be better understood and apparent to one skilled in the relevant art in view of the detailed description and drawings that follow, in which various embodiments are illustrated by way of example. It is to be expressly understood, however, that the drawings are for the purpose of illustration only and are not intended as a definition of the limits of the claimed invention.

### BRIEF DESCRIPTION OF THE DRAWINGS

FIG. 1 depicts metadata services with multiple sources as provided by the product enhancer server according to an embodiment;

FIG. 2 depicts the design flow chart of the Sony electronic program guide metadata service according to an embodiment;

FIG. 3 depicts the API scenario of the electronic program guide metadata service according to an embodiment;

FIG. 4 depicts the client software architecture for metadata services according to an embodiment.

### DETAILED DESCRIPTION OF EXEMPLARY EMBODIMENTS

Embodiments of the present invention create a unified interface for electronic program guide data and metadata, to combine the information from multiple providers to enhance the TV and media experience on consumer electronics products. By providing a common gateway to connect consumer electronics products, the embodiments simplify the process of developing world wide products and create opportunities for future business concepts around electronic program guide data and metadata.

### I. Rich Metadata Services

The worldwide Rich Metadata Service project was established to meet the demands of enabling various applications in consumer electronics products with access to metadata for broadcast contents and internet services. To coordinate and manage multiple metadata service sources, Sony introduces the Product Enhancer (also known as the Metadata Frontend Engine or MFE) server concept to connect multiple metadata sources with numerous Sony consumer electronics devices.

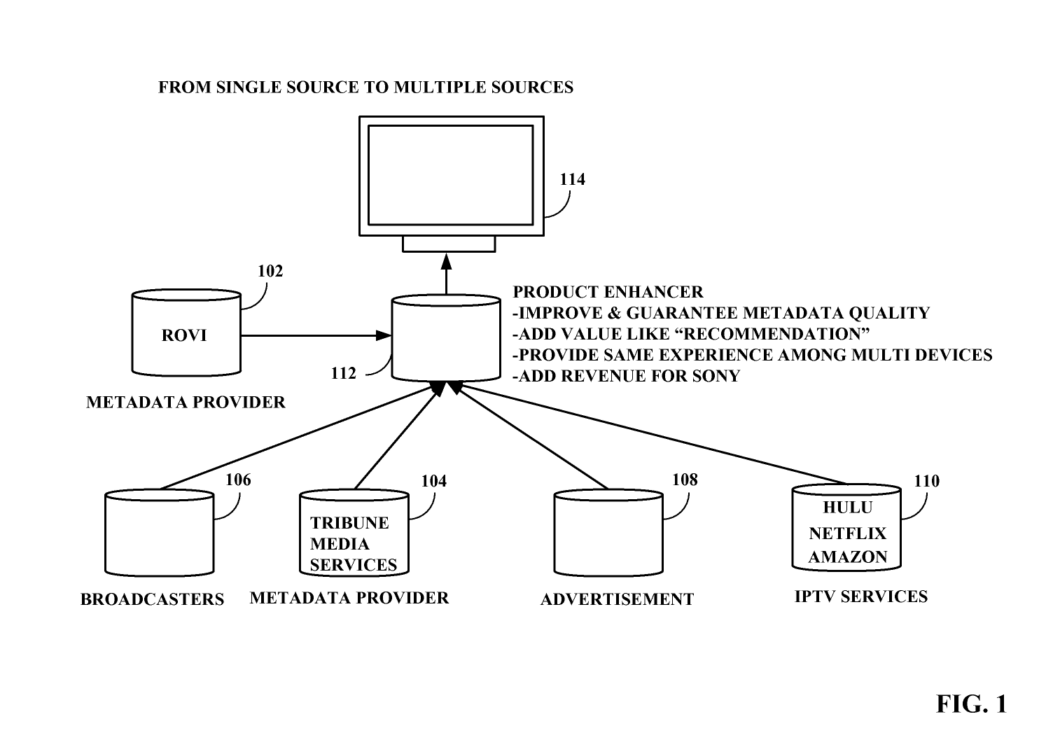

FIG. 1 depicts metadata services with multiple sources as provided by the product enhancer server. Metadata providers 102, such as Rovi™ (Rovi is a trademark of Rovi Corporation) and 104 such as Tribune Media Services™ (Tribune Media Services is owned by the Tribune Company), as well as broadcasters 106, advertisement sources 108, and IPTV services 110 such as Hulu™ (Hulu is a trademark of Hulu, a joint venture company), Netflix™ (Netflix is a trademark of Netflix, Inc.), and Amazon.com® (Amazon.com is a registered trademark of Amazon.com, Inc.), for example all send input to the server 112. The server then provides coordinated input to consumer electronics device 114, which is shown here as a television merely as an example. Many different types of consumer electronics devices are within the scope of the present invention, including for example a smartphone, a laptop computer, a video game, a tablet computer, a personal digital assistant (PDA), and a personal computer.

### II. EPG Metadata Service

From the development experience of Sony DTV (digital television), IPTV (internet protocol television) and audio/visual (A/V) platforms in recent years, Sony has become aware of a need to have its own solution for electronic program guide data and metadata services which can satisfy the demands of various applications in consumer electronics products with broadcast contents and internet services. The development of a Sony Electronic Program Guide and Metadata Service is a result of this guideline. The electronic program guide and metadata services may provide functionality such as:

### Traditional Electronic Program Guide Applications on TV:

Grid electronic program guide with tuning.

Program description with OSD (on-screen display)/banner and menu.

Channel category and program search.

Timer and DVR (digital video recorder) recording.

### Enhanced Metadata Features Through an Internet Connection:

Metadata Content Services, e.g. Audio/Video/Media Explorers.

IPTV streaming, e.g. Video on demand, live streaming.

Recommendation and Advertisement.

Social Networking applications.

The traditional method to deliver the electronic program guide data and metadata to consumer electronics devices by embedding data within the broadcast signal cannot satisfy today's requirements of interaction of metadata and broadcast/media contents using an IPG (Interactive Program Guide). TV broadcast and A/V streaming contents need more sophisticated retrieval mechanisms to enable applications of program and content guide access to multiple sources of metadata services through an internet connection. A flexible delivery process for electronic program guide data and a real-time interface mechanism for metadata among services in servers and various consumer electronics devices are also required.

### III. Sony Metadata Service Design

### The Development Strategies of the Sony EPG/Metadata Design are:

Modem client-server architecture through an IP (internet protocol) network.

Stateless transactions to support “cloud” computing and cloud storage.

Support combining and filtering multiple sources of metadata databases.

Unify the Sony electronic program guide data interface (i.e. API or application program interface) to provide a single world wide IPTV API.

Provide a mechanism for Sony to transparently switch metadata service providers without requiring costly client side software updates and modifications.

Allow for integration of Sony electronic program guide service with other internet services, e.g. A/V explorer with related advertisement or promotional services.

Ability to enhance metadata related features or services without impacting the existing client products or devices.

Decouple the software development of the client from the server.

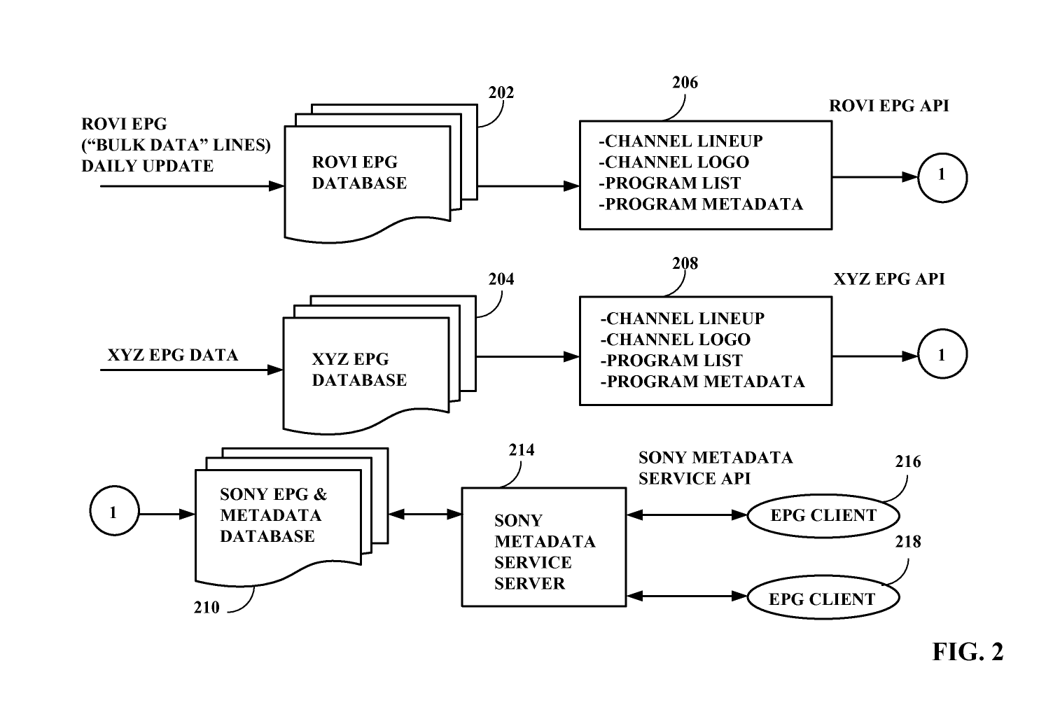

FIG. 2 depicts the design flow chart of the Sony electronic program guide metadata service. Content providers such as Rovi™ and fictitious XYZ assemble their data into respective EPG databases 202 and 204. Each provider may then utilize their own EPG API to generate outputs, shown here as items 206 and 208. Each output typically contains a detailed channel lineup, with individual channel logos, a program list, and program metadata. Each output is collected by the Sony EPG & Metadata Database Manager 210, which along with the Sony EPG & Metadata Service Manager 212 (not shown in this Figure) comprise the EPG & Metadata Core of the Sony Product Enhancer Server 214. Individual EPG clients, shown as 216 and 218, receive processed content from server 214 via a Sony Metadata Service API.

### IV. Sony Metadata Service API

The API design of the Sony Metadata Service will support both concepts of a “Thin (Lean or Slim) Client” and a “Fat (Thick) Client” at the same time. The electronic program guide client may apply the combination of both a fat client and a thin client architecture. For example, a client application could apply a fat client approach for basic electronic program guide features and then to supplement the design with a thin client approach for more advanced electronic program guide features (i.e. catalog searching, celebrity profile, etc.). The Sony metadata service handles and manages the growing volumes of increasingly complex data associated with rich content to meet the performance and memory budgets of various consumer electronics devices. The metadata may incorporate various file formats. i.e. TXT, protocol buffer, JSON, XML and so on, which is embedded within the response to the client request, and can be downloaded as individual files per client demands.

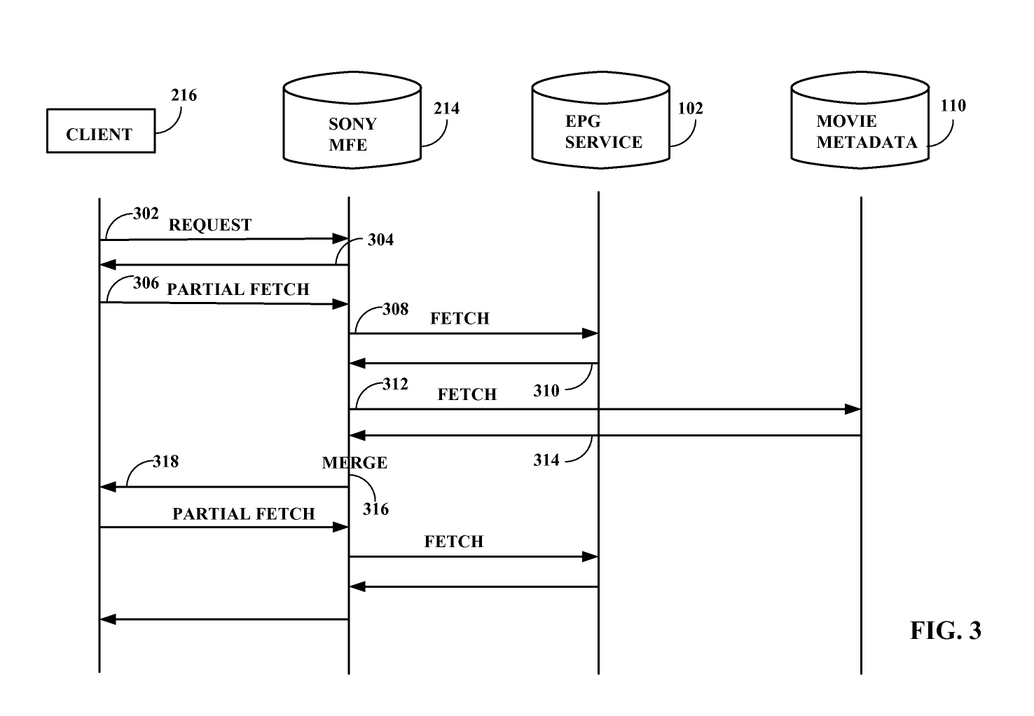

FIG. 3 depicts the API scenario of the electronic program guide metadata service. In step 302, client 216 issues a request to server 214, which returns data corresponding to the request in step 304. Client 216 may issue a partial fetch request in step 306 if additional data is required. Server 214 may then issue a fetch request in step 308 to an EPG service 102 previously described, which returns corresponding data in step 310. An additional fetch request in step 312 may be issued to another service provider, such as movie metadata source 110 previously described; the corresponding data is returned in step 314. Server 214 may then merge the fetched data in step 316 and return the merged data to client 216 in step 318. Additional fetch requests may continue until client 216 is satisfied.

### V. Client Software Architecture Overview

By using a cloud service approach, the client software needs to support only a single source of electronic program guide metadata, while the server handles the translation from one metadata format to another. This allows the flexibility to switch from one service provider to another service provider while maintaining the same look and feel for the customer, and with no changes to the client applications. The architecture incorporates these considerations:

Focus on metadata sources primarily through a network connection. Clients can still download the metadata source from traditional broadcast electronic program guide service, but the path forward is IP based sourcing of metadata.

Leverage the electronic program guide metadata service with other internet services and applications, e.g. IPTV, audio/video/media explorers, recommendations/advertisements and other services.

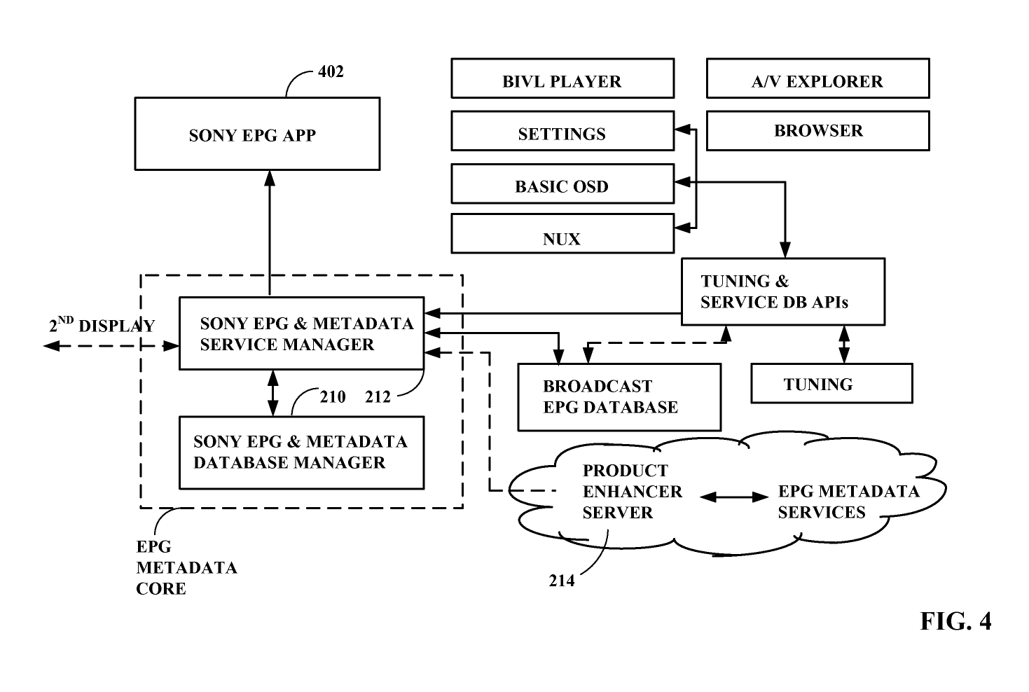

FIG. 4 depicts an exemplary implementation of the client software architecture for metadata services. EPG & Metadata Core may output data to Sony EPG application 402 on a particular consumer electronics device, and optionally to at least one additional device, marked as “2nd Display” in this figure.

### VI. Conclusion

With the development of this Sony Metadata Service via a unified API to the Product Enhanced Server, Sony can create new business opportunities to develop new metadata services with Sony consumer electronics devices and enhance existing features with Sony provided services. By leveraging a unified interface in the Sony metadata service, embodiments of the present invention provide a common and centralized service gateway to connect Sony consumer electronics products with Sony internal services and external internet services for future business opportunities.

As used herein, the terms “a” or “an” shall mean one or more than one. The term “plurality” shall mean two or more than two. The term “another” is defined as a second or more. The terms “including” and/or “having” are open ended (e.g., comprising). Reference throughout this document to “one embodiment”, “certain embodiments”, “an embodiment” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation. The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

In accordance with the practices of persons skilled in the art of computer programming, embodiments are described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the embodiments are essentially the code segments to perform the necessary tasks. The non-transitory code segments may be stored in a processor readable medium or computer readable medium, which may include any medium that may store or transfer information. Examples of such media include an electronic circuit, a semiconductor memory device, a read-only memory (ROM), a flash memory or other non-volatile memory, a floppy diskette, a CD-ROM, an optical disk, a hard disk, a fiber optic medium, etc. User input may include any combination of a keyboard, mouse, touch screen, voice command input, etc. User input may similarly be used to direct a browser application executing on a user's computing device to one or more network resources, such as web pages, from which computing resources may be accessed.

While the invention has been described in connection with specific examples and various embodiments, it should be readily understood by those skilled in the art that many modifications and adaptations of the invention described herein are possible without departure from the spirit and scope of the invention as claimed hereinafter. Thus, it is to be clearly understood that this application is made only by way of example and not as a limitation on the scope of the invention claimed below. The description is intended to cover any variations, uses or adaptation of the invention following, in general, the principles of the invention, and including such departures from the present disclosure as come within the known and customary practice within the art to which the invention pertains.

What is claimed is:

1. A computer-implemented method for utilizing electronic program guide data and metadata from multiple service sources, comprising:
receiving input comprising at least one of electronic program guide data and metadata from a plurality of content providers;
combining the input in a common gateway server; and
generating a unified interface for at least one consumer electronics device.

2. The method of claim 1, wherein the electronic program guide data comprises at least one of a channel lineup, a channel logo, a program list, and DVR instructions.

3. The method of claim 1, wherein the metadata comprises information regarding at least one of streaming video, explorer tools, recommendations, customized advertisements, and social networking applications.

4. The method of claim 1, wherein the metadata comprises file formats including at least one of text, protocol buffer, JSON, and XML.

5. The method of claim 1, wherein the content providers comprise at least one of broadcasters, advertisement providers, metadata providers, IPTV providers, and movie providers.

6. The method of claim 1, wherein the receiving is from at least one of a broadcast source, a network source, and the internet.

7. The method of claim 1, wherein the combining comprises at least one of filtering data, transcoding data from at least one external application program interface, and merging data.

8. The method of claim 1, wherein the combining comprises transparently switching between metadata service providers.

9. The method of claim 1, wherein the common gateway server comprises a service manager and a database manager.

10. The method of claim 1, wherein the unified interface comprises an application program interface common to a plurality of the consumer electronic devices.

11. The method of claim 1, wherein the consumer electronics device comprises at least one of a smartphone, a television set, a laptop computer, a tablet computer, a personal digital assistant, a video game, and a personal computer.

12. The method of claim 1, further comprising integrating electronic program guide service with related advertisements.

13. The method of claim 1, wherein the method operates in substantially real-time.

14. A system for utilizing electronic program guide data and metadata from multiple service sources, comprising:
a processor; and
a memory containing instructions that, when executed by the processor cause the processor to:
receive input comprising at least one of electronic program guide data and metadata from a plurality of content providers;
combine the input in a common gateway server; and
generate a unified interface for at least one consumer electronics device.

15. The system of claim 14, wherein the metadata comprises information regarding at least one of streaming video, explorer tools, recommendations, customized advertisements, and social networking applications.

16. The system of claim 14, wherein the combining comprises at least one of filtering data, transcoding data from at least one external application program interface, and merging data.

17. The system of claim 14, wherein the unified interface comprises an application program interface common to a plurality of the consumer electronic devices.

18. The system of claim 14, wherein the consumer electronics device comprises at least one of a smartphone, a television set, a laptop computer, a tablet computer, a personal digital assistant, a video game, and a personal computer.

19. A computer program product for utilizing electronic program guide data and metadata from multiple service sources, comprising a computer readable medium tangibly embodying non-transitory computer-executable program instructions thereon that, when executed, cause a computing device to:
receive input comprising at least one of electronic program guide data and metadata from a plurality of content providers;
combine the input in a common gateway server; and
generate a unified interface for at least one consumer electronics device.

20. A system for utilizing electronic program guide data and metadata from multiple service sources, comprising:
means for receiving input comprising at least one of electronic program guide data and metadata from a plurality of content providers;
means for combining the input in a common gateway server; and
means for generating a unified interface for at least one consumer electronics device.
